(19) United States
(12) Patent Application Publication
(10) Pub. No.: US 2009/0001795 A1
(43) Pub. Date: Jan. 1, 2009

(54) Fold Flat Seat Assembly

(76) Inventors: Robert I. Homier, Plymouth, MI (US); Carl J. Holdampf, Farmington Hills, MI (US)

Correspondence Address: MAGNA INTERNATIONAL, INC., 337 MAGNA DRIVE, AURORA, ON, L4G-7K1, CA

(21) Appl. No.: 12/158,067

(22) PCT Filed: Jan. 5, 2007
(86) PCT No.: PCT/CA07/00018

§ 371 Date: Jun. 19, 2008

Related U.S. Application Data
(60) Provisional application No. 60/756,410, filed on Jan. 5, 2006.

(51) Int. Cl. B60N 2/02; B60N 2/30; B60N 2/22

(52) U.S. Cl. 297/341; 297/340

(57) ABSTRACT

A seat assembly includes a seat cushion and seat back for supporting an occupant above a floor in a motor vehicle. The seat back is operatively mounted for pivotal movement relative to the seat cushion between an upright seating position and a rearwardly folded bed flat position. A guide link slidably engages the seat cushion for guiding and supporting the seat cushion between a seating position and a raised position. A drive link couples the seat back to the seat cushion for automatically moving the seat cushion between the seating and raised positions, wherein the seat cushion is aligned horizontally level with the seat back, in response to pivoting the seat back between the upright seating position and the rearwardly folded bed flat position.

### FIELD OF THE INVENTION

The invention relates to a seat assembly for a motor vehicle. More particularly, the invention relates to a drive link for automatically moving a seat cushion horizontally level with a seat back in response to pivoting the seat back from an upright seating position to a rearwardly folded bed flat position.

### BACKGROUND OF THE INVENTION

Automotive vehicles include seat assemblies for supporting occupants within the vehicle. Seat assemblies include a generally horizontal seat cushion having an upper seating surface and a generally vertical or upright seat back having a front supporting surface. Typically, a lower end of the seat back is operatively coupled to a rear end of the seat cushion by a recliner mechanism allowing for selective pivotal adjustment of the seat back relative to the seat cushion between a plurality of reclined seating positions.

Oftentimes, the seat back is movable between any of the plurality of reclined seating positions and a forwardly folded stowed position in which the front supporting surface of the seat back is overlying the upper seating surface of the seat cushion. When the seat back is in the forwardly folded stowed position a back surface of the seat back defines a cargo load floor surface.

Additionally, the seat back may be movable between any of the plurality of reclined seating positions and a rearwardly folded bed flat position in which the front supporting surface of the seat back is generally horizontal. In the rearwardly folded bed flat position, the upper seating surface of the seat cushion and the front supporting surface of the seat back define a bed surface.

As currently practiced in the seating art, however, the recliner mechanism operatively coupled between the lower end of the seat back and the rear end of the seat cushion results in a step condition between the seat back and seat cushion when the seat back is in the rearwardly folded bed flat position. In other words, when the seat back is moved into the rearwardly folded bed flat position, the lower end of the seat back is disposed higher than or upward of the rear end of the seat cushion resulting in an offset or step condition between the seat back and seat cushion.

It is therefore desirable to provide a drive link operatively coupled between the seat back and seat cushion to align the upper seating surface of the seat cushion with the front supporting surface of the seat back when the seat back is in the rearwardly folded bed flat position. It is also desirable that the drive link move the seat cushion forward and downward when the seat back is in the forwardly folded stowed position.

### SUMMARY OF THE INVENTION

According to one aspect of the invention, a seat assembly is provided for supporting an occupant above a floor in a motor vehicle. The seat assembly includes a seat cushion having an upper seating surface and a seat back having a front supporting surface. The seat assembly also includes a front link that extends between a first end pivotally coupled to the seat cushion and a second end adapted to be pivotally coupled to the floor. The seat assembly includes a guide link slidably couples the seat cushion for guiding and supporting the seat cushion between a forwardly fold flat position, a seating and a raised position. The seat back is operative for selective pivotal movement relative to said seat cushion between a folded forward position, an upright seating position and a rearwardly folded bed flat position generally horizontal. The seat assembly further includes a drive link that extends between a first end pivotally coupled to the seat back and a second end pivotally coupled to the seat cushion. The drive link automatically moves the seat cushion between the forwardly fold flat position, the seating position and the raised position, wherein the upper seating surface of the seat cushion is aligned horizontally level with the front supporting surface of the seat back, in response to pivotal movement of the seat back between a forwardly fold flat position, an upright seating position and a rearwardly folded bed flat position.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 is a side view of a seat assembly in a seating position according to the invention;

FIG. 2 is a side view of the seat assembly in a stowed position; and

FIG. 3 is a side view of the seat assembly in a bed flat position.

### DETAILED DESCRIPTION OF THE PREFERRED EMBODIMENT

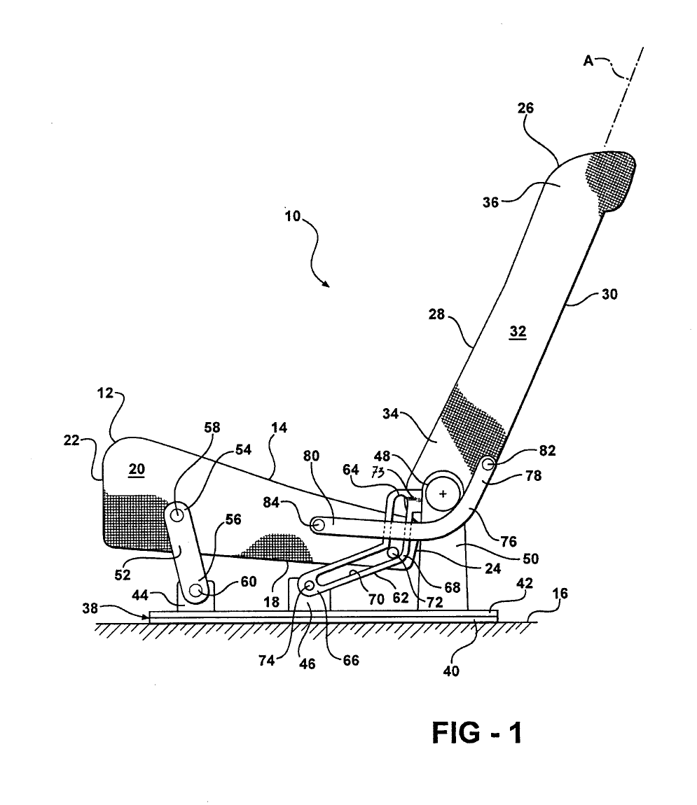

Referring to FIG. 1, a seat assembly for an automotive vehicle is generally shown at 10. The seat assembly 10 is shown in a seating position and includes a generally horizontal seat cushion 12. The seat cushion 12 includes an upper seating surface 14 for supporting a seat occupant above a floor 16 of the vehicle, an opposite bottom surface 18, and side surfaces 20 (one shown). The seat cushion 12 extends between a front end 22 and a rear end 24. The seat assembly 10 also includes a generally vertical seat back 26. The seat back 26 includes a front supporting surface 28 for supporting a back of the seat occupant, an opposite back surface 30, and side surfaces 32 (one shown). The seat back 26 extends between a lower end 34 and an upper end 36.

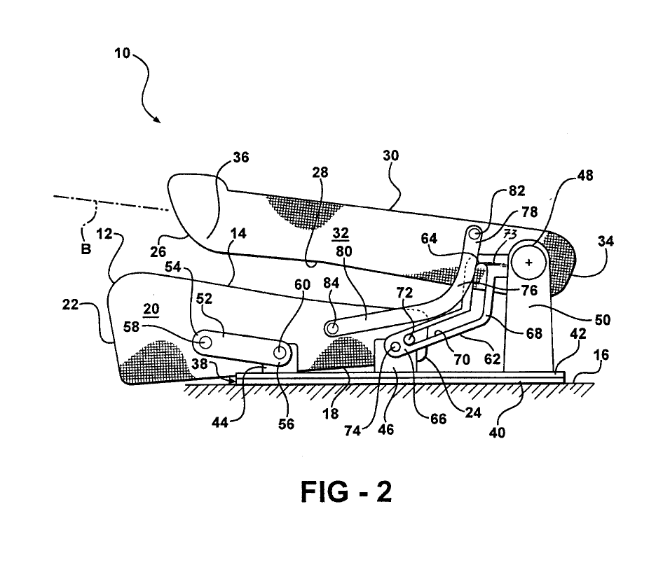

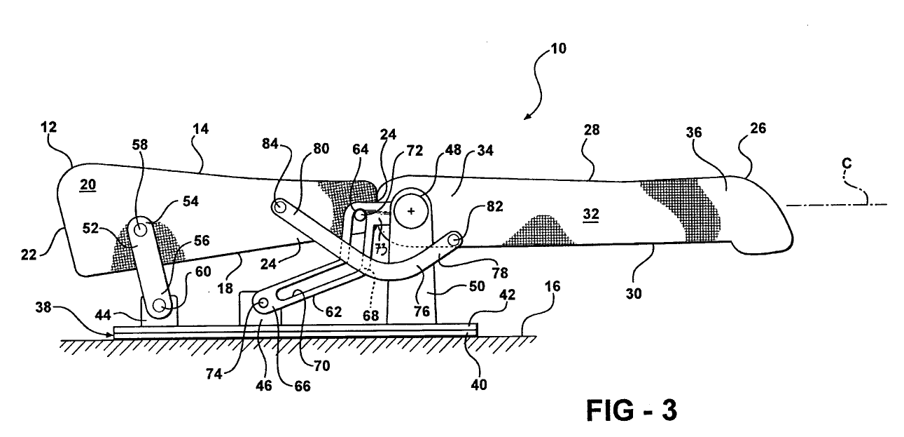

The seat back 26 is operatively coupled to the seat cushion 12 for movement between an upright seating position at A, as shown in FIG. 1, a forwardly folded stowed position at B, as shown in FIG. 2, and a rearwardly folded bed flat position at C, as shown in FIG. 3. The seat assembly 10 is movable between a seating position, shown in FIG. 1, a stowed position, shown in FIG. 2, and a bed flat position, shown in FIG. 3. In the seating position, the seat back 26 is in the upright seating position A and the seat cushion 12 is in a seating position spaced above the floor 16. In the stowed position, the seat cushion 12 is in a lowered position, downward and forward of the seating position, lying generally along the floor 16 and the seat back 26 is in the forwardly folded stowed position B such that the front supporting surface 28 of the seat back 26 is overlying the upper seating surface 14 of the seat cushion 12. Finally, in the bed flat position, the seat back 26 is in the rearwardly folded bed flat position C and the seat cushion 12 is in a raised position such that the upper seating surface 14 of the seat cushion 12 is generally horizontally aligned with the front supporting surface 28 of the seat back 26.

It will be appreciated that while only one side of the seat assembly 10 is shown in the Figures, both an inboard side and an outboard side are substantially the same. In the embodiment shown, a track assembly, generally indicated at 38, is provided for adjusting the seat assembly 10 fore and aft within the vehicle. The track assembly 38 includes a lower fixed track 40 that is adapted to be mounted to the vehicle floor 16 and an upper movable track 42 that is selectively slidable with respect to the fixed track 40. The track assembly 38 is well known in the art and includes assemblies such as disclosed in U.S. Pat. No. 5,741,000 to Goodbred. A front riser 44 and a rear riser 46 are spaced apart and fixedly mounted to the upper movable track 42 for mounting the seat assembly 10 to the track assembly 38.

A recliner mechanism 48 is disposed between the lower end 34 of the seat back 26 and a seat back bracket 50 for providing selective angular adjustment of the seat back 26 relative to the seat cushion 12. The seat back bracket 50 is fixedly mounted to the upper movable track 42. The recliner mechanism 48 allows the seat back 26 to be adjusted between a plurality of reclined seating positions, one of which is the upright seating position A shown in FIG. 1. In addition, the recliner mechanism 48 allows the seat back 26 to be adjusted between any of the plurality of reclined seating positions, the forwardly folded stowed position B, and the rearwardly folded bed flat position C. The recliner mechanism 48 is actuated between a locked condition and an unlocked condition by a release lever (not shown). In the locked condition, the recliner mechanism 48 maintains the seat back 26 in one of the plurality of reclined seating positions. In the unlocked condition, the seat back 26 may be freely adjusted between any of the plurality of reclined seating positions and the forwardly folded stowed position B or the rearwardly folded bed flat position C.

A front link 52 is disposed adjacent to the side surface 20 of the seat cushion 12. The front link 52 extends linearly between a first end 54 and a second end 56. The first end 54 is pivotally coupled to the side surface 20 of the seat cushion 12, at the front end 22, by pivot pin 58. The second end 56 is pivotally coupled to the front riser 44 by pivot pin 60.

A guide link 62 is disposed adjacent to the side surface 20 of the seat cushion 12. In the embodiment shown, the guide link 62 is generally L-shaped and extends between a first end 64 and a second end 66. An elbow 68 is disposed between the first 64 and second 66 ends. The guide link 62 includes a slot 70 extending along the length of the guide link 62 between the first 64 and second 66 ends. A slide pin 72 is fixedly secured to the side surface 20 of the seat cushion 12, at the rear end 24. The slide pin 72 extends laterally from the side surface 20 and is disposed in the slot 70 slidingly coupling the guide link 62 to the seat cushion 12 for guiding and supporting the seat cushion 12 between the seating, lowered, and raised positions. The first end 64 of the guide link 62 is coupled to the seat back bracket 50 by tab 73. The second end 66 is coupled to the rear riser 46 by fixed pin 74. When the seat assembly 10 is in the seating position, the slide pin 72 is disposed in the slot 70 at the elbow 68 of the guide link 62. When the seat assembly 10 is in the stowed position, the slide pin 72 is disposed in the slot 70 at the second end 66 of the guide link 62. When the seat assembly 10 is in the bed flat position, the slide pin 72 is disposed in the slot 70 at the first end 64 of the guide link 62. Although not shown, it will be appreciated that the guide link 62 may include a latch for engaging and securing the slide pin 72 in the slot 70 at the elbow 68, second end 66, and first end 64 depending on the respective position of the seat assembly 10.

A drive link 76 is disposed adjacent to and outboard of the guide link 62. The drive link 76 extends between a first end 78 and a second end 80. In the embodiment shown, the drive link 76 has a curvature or bend between the first end 78 and the second end 80. The first end 78 is pivotally coupled to the side surface 32 of the seat back 26, adjacent the lower end 34, by pivot pin 82. The second end 80 is pivotally coupled to the side surface 20 of the seat cushion 12, adjacent the rear end 24, by pivot pin 84.

In operation, starting with the seat assembly 10 in the seating position, as shown in FIG. 1, the release handle is actuated to unlock the recliner mechanism 48. The seat back 26 is then pivoted forward toward the forwardly folded stowed position B. The forward pivotal movement of the seat back 26 urges the first end 78 of the drive link 76 forward and the second end 80 of the drive link 76 downward and forward. In response, the seat cushion 12 moves downward and forward. At the same time, the second end 56 of the front link 52 pivots about pivot pin 60 in a counterclockwise direction (when viewed from FIG. 1) and the slot 70 in the guide link 62 guides the slide pin 72 from the elbow 68 to the second end 66 such that the seat cushion 12 moves from the seating position to the lowered position. When the front supporting surface 28 of the seat back 26 abuts the upper seating surface 14 of the seat cushion 12 the seat assembly 10 is in the stowed position, as shown in FIG. 2. In the stowed position, the back surface 30 of the seat back 26 is disposed generally horizontal to the floor 16 defining a cargo load floor surface.

Starting again with the seat assembly 10 in the seating position, the release handle is actuated to unlock the recliner mechanism 48. The seat back 26 may also be pivoted rearward toward the rearwardly folded bed flat position C. The rearward pivotal movement of the seat back 26 urges the first end 78 of the drive link 76 downward and rearward and the second end 80 of the drive link 76 upward. In response, the rear end 24 of the seat cushion 12 moves upward and the slot 70 in the guide link 62 guides the slide pin 72 from the elbow 68 to the first end 64 such that the seat cushion 12 moves from the seating position to the raised position. When the upper seating surface 14 of the seat cushion 12 is horizontally aligned with the front supporting surface 28 of the seat back 26, the seat assembly 10 is in the bed flat position, as shown in FIG. 3. In the bed flat position, the upper seating surface 14 of the seat cushion 12 and the front supporting surface 28 of the seat back 26 are disposed horizontally relative to the floor 16.

The invention has been described here in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A seat assembly for supporting an occupant above a floor in a motor vehicle, said seat assembly comprising:
a seat track assembly configured for mounting on said vehicle floor;
a seat back including a front supporting surface, said seat back operatively coupled to said seat track assembly for selective pivotal movement between an upright seating position and a rearwardly folded bed flat position generally parallel to the floor;
a seat cushion including an upper seating surface;
a front link pivotally coupling a front end of said seat cushion to the seat track assembly;
a guide link slidably coupling a rear end of said seat cushion to said seat track assembly, said guide link guiding movement of said seat cushion between a seating position and a raised position; and
a drive link operatively coupling said seat back to said seat cushion for automatically moving said seat cushion between said seating position and said raised position, wherein said upper seating surface of said seat cushion is aligned with said front supporting surface of said seat back, in response to pivotal movement of said seat back between said upright seating position and said rearwardly folded bed flat position.

2. A seat assembly as set forth in claim 1 wherein said seat back is selectively movable between said upright seating position and a forwardly folded stowed position overlying said seat cushion.

3. A seat assembly as set forth in claim 2 wherein said drive link automatically moves said seat cushion between said seating position and a lowered position downward and forward of said seating position in response to pivotal movement of said seat back from said upright seating position to said forwardly folded stowed position, and said guide link guides said seat cushion between said seating and lowered positions.

4. A seat assembly as set forth in claim 3 including a seat back bracket adapted to be fixedly secured to the seat track assembly.

5. A seat assembly as set forth in claim 4 wherein said guide link has a generally L-shaped slot including an elbow, and said seat cushion has a pin slidably engaging within said slot for travel between a first end and a second end of said slot, and said guide link is fixedly secured to said seat back bracket.

6. A seat assembly as set forth in claim 5 including a recliner mechanism disposed between a lower end of said seat back and said seat back bracket providing selective pivotal adjustment of said seat back between said upright seating position, a plurality of reclined seating positions, said forwardly folded stowed position, and said rearwardly folded bed flat position.

7. A seat assembly as set forth in claim 6 wherein a first end of said drive link is pivotally coupled to a lower end of said seat back and a second end of said drive link is pivotally coupled to said rear end of said seat cushion.

8. A seat assembly as set forth in claim 7 wherein said slide pin is disposed in said slot at said elbow when said seat back is in said upright seating position, at said first end of said slot when said seat back is in said rearwardly folded bed flat position, and at said second end of said slot when said seat back is in said forwardly folded stowed position.

9. A seat assembly as set forth in claim 8 wherein said track assembly provided selective fore and aft adjustment of said seat assembly within the vehicle.

10. A seat assembly for supporting an occupant above a floor in a motor vehicle, said seat assembly comprising:
a seat back including a front supporting surface, said seat back operatively coupled to said floor for selective pivotal movement between an upright seating position and a rearwardly folded bed flat position generally parallel to the floor;
a seat cushion including an upper seating surface;
a front link pivotally coupling a front end of said seat cushion to the floor;
a guide link slidably coupling a rear end of said seat cushion to said floor, said guide link guiding movement of said seat cushion between a seating position and a raised position; and
a drive link operatively coupling said seat back to said seat cushion for automatically moving said seat cushion between said seating position and said raised position, wherein said upper seating surface of said seat cushion is aligned with said front supporting surface of said seat back, in response to pivotal movement of said seat back between said upright seating position and said rearwardly folded bed flat position.

11. A seat assembly as set forth in claim 10 wherein said seat back is selectively movable between said upright seating position and a forwardly folded stowed position overlying said seat cushion.

12. A seat assembly as set forth in claim 11 wherein said drive link automatically moves said seat cushion between said seating position and a lowered position downward and forward of said seating position in response to pivotal movement of said seat back from said upright seating position to said forwardly folded stowed position, and said guide link guides said seat cushion between said seating and lowered positions.

13. A seat assembly as set forth in claim 12 including a seat back bracket adapted to be fixedly secured to the floor, said seat back bracket pivotally engaging said seat back.

14. A seat assembly as set forth in claim 13 wherein said guide link has a generally L-shaped slot including an elbow and said seat cushion has a pin slidably engaging within said slot for travel between a first end and a second end of said slot, and said guide link is fixedly secured to said seat back bracket.

15. A seat assembly as set forth in claim 14 including a recliner mechanism disposed between a lower end of said seat back and said seat back bracket, said recliner mechanism providing selective pivotal adjustment of said seat back between said upright seating position, a plurality of reclined seating positions, said forwardly folded stowed position, and said rearwardly folded bed flat position.

16. A seat assembly as set forth in claim 15 wherein a first end of said drive link is pivotally coupled to said lower end of said seat back and a second end of said drive link is pivotally coupled to said rear end of said seat cushion.

17. A seat assembly as set forth in claim 16 wherein said slide pin is disposed at said slot at said elbow when said seat back is in said upright seating position, at said first end of said slot when said seat back is in said rearwardly folded bed flat position, and at said second end of said slot when said seat back is in said forwardly folded stowed position.
